(19) United States
(12) Patent Application Publication
(10) Pub. No.: US 2015/0062147 A1
(43) Pub. Date: Mar. 5, 2015

(54) DISPLAY METHOD FOR BACKGROUND OF APPLICATION PROGRAM AND MOBILE TERMINAL

(71) Applicant: DONGGUAN GOLDEX COMMUNICATION TECHNOLOGY CO., LTD., Dongguan, GD (CN)

(72) Inventor: Lirong Liu, Dongguan (CN)

(73) Assignee: DONGGUAN GOLDEX COMMUNICATION TECHNOLOGY CO., LTD., Dongguan, GD (CN)

(21) Appl. No.: 14/381,112

(22) PCT Filed: Oct. 23, 2013
(86) PCT No.: PCT/CN2013/085801

§ 371 Date: Aug. 26, 2014

(30) Foreign Application Priority Data
Jan. 14, 2013 (CN) 201310012914.5

(51) Int. Cl. G06T 11/60; H04N 5/225; G06T 11/00

(52) U.S. Cl. CPC G06T 11/60; G06T 11/001; H04N 5/225
USPC 345/592; 345/632

(57) ABSTRACT

Embodiments of the present invention disclose a display method for background of application program and a mobile terminal. The method includes the following steps: capturing image information, where the image information includes current environment information; separating a background displaying layer of a currently running application program; adding the image information to the background displaying layer of the currently running application program; and displaying the image information as a background of the currently running application program. According to the present invention, image information captured by using a camera may be used as a background of an application program, so that users can use an application program of a mobile terminal conveniently when walking.

This application claims the benefit and priority to Chinese Patent Application No. 201310012914.5, filed with the Chinese Patent Office on Jan. 14, 2013 and entitled “DISPLAY METHOD FOR BACKGROUND OF APPLICATION PROGRAM AND MOBILE TERMINAL”, which is incorporated herein by reference in its entirety.

### FIELD OF THE INVENTION

The present invention relates to the field of electronics technologies, and in particular, to a display method for background of application program, and a mobile terminal.

### BACKGROUND OF THE INVENTION

This section provides background information related to the present disclosure which is not necessarily prior art.

With the development of science and technology, functions of mobile terminals such as cell phones and tablet computers, become increasingly powerful. This kind of mobile terminal has already become an indispensable part of people' daily life. It is a common scene that pedestrians use mobile terminals while walking. However, in the process of using a mobile terminal, the eyes of a user have to watch surroundings from time to time, affecting user experience, and a major or minor safety problem may also occur because a user is too obsessed with the mobile terminal.

### SUMMARY

This section provides a general summary of the disclosure, and is not a comprehensive disclosure of its full scope or all of its features.

Embodiments of the present invention provide a display method for background of application program, and a mobile terminal, where environment information may be used as a background of an application program.

An embodiment of the present invention provides a display method for background of application program, including:

capturing image information, where the image information includes current environment information;

separating a background displaying layer of a currently running application program;

adding the image information to the background displaying layer of the currently running application program; and

displaying the image information as a background of the currently running application program.

Accordingly, an embodiment of the present invention provides a mobile terminal, including:

a capturing module, configured to capture image information, where the image information includes current environment information;

a separating module, configured to separate a background displaying layer of a currently running application program to at least two layers;

an adding module, configured to add the image information to the background displaying layer of the currently running application program; and

a displaying module, configured to display the image information as a background of the currently running application program.

In the embodiments of the present invention, image information which includes current environment information is used as a background of an application program for displaying, which enables a user to see clearly surroundings through the background of the application program when using the application program at the same time, so that the user can use the application program more conveniently and safely.

### BRIEF DESCRIPTION OF DRAWINGS

To describe the technical solutions in the embodiments of the present invention more clearly, the following briefly introduces accompanying drawings required for describing the embodiments. Apparently, the accompanying drawings in the following description show some embodiments of the present invention, and a person of ordinary skill in the art may still derive other drawings according to these accompanying drawings without creative efforts.

FIG. 1 is an exemplary flowchart of a display method for background of application program, in accordance with an embodiment of the present invention;

FIG. 2 is an exemplary flowchart of another display method for background of application program, in accordance with an embodiment of the present invention;

FIG. 3 is a modularization schematic diagram of a mobile terminal, in accordance with an embodiment of the present invention;

FIG. 4 is a modularization schematic diagram of an adding module, in accordance with FIG. 3; and

FIG. 5 is a modularization schematic diagram of another mobile terminal, in accordance with an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

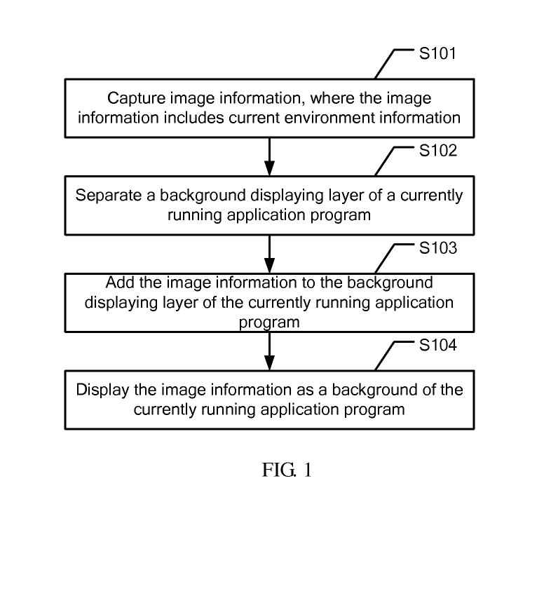

Referring to FIG. 1, FIG. 1 is an exemplary flowchart of a display method for background of application program, in accordance with an embodiment of the present invention. As shown in FIG. 1, the method according to the embodiment of the present invention includes the following steps:

S101. Capture image information, where the image information includes current environment information.

Specifically, at the same time when a user enables an application program, a camera is also automatically turned-on and image information starts to be captured by using the camera, where a captured image is an image taken by the camera, the image information includes current environment information, that is, the captured image includes environment information about current surroundings, for example, road condition, a pedestrian, or a utility pole which is shot by the camera, and the application program may include an SMS (Short Message Service) message, a microblog or twitter, a WeChat, an e-book, etc.

S102. Separate a background displaying layer of a currently running application program.

The background displaying layer of the currently running application program is set to two layers, where the two layers are a background first-layer and a background second-layer, and the background first-layer covers the background second-layer. A background is separated to two layers, so as to add the image information to the background displaying layer.

S103. Add the image information to the background displaying layer of the currently running application program.

Specifically, the background displaying layer of the application program may be set to two layers, where one layer is set to a built-in background of the application program, and the other layer is set to the image information, that is, the image information is added to the background displaying layer of the currently running application program, and the built-in background of the application program covers the image information.

S104. Display the image information as a background of the currently running application program.

Specifically, the background displaying layer of the application program includes the built-in background of the application program and the image information that is captured by using the camera. The built-in background is made transparent until the image information, which is located at the layer under the built-in background, can be displayed clearly. In this case, the displayed background of the application program is the image information at the background displaying layer. Both the image information and the application program are displayed to the user, so that the user can see clearly the current environment information through the background of the application program when using the application program at the same time.

In the embodiment of the present invention, image information which includes current environment information is used as a background of an application program for displaying, which enables a user to see clearly surroundings through the background of the application program when using the application program at the same time, so that the user can use the application program more conveniently and safely when walking, on vehicle, etc.

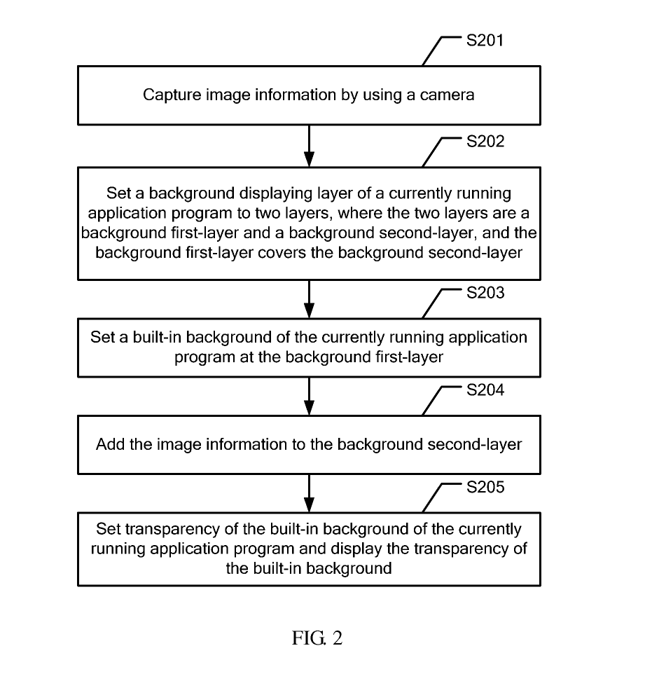

Referring to FIG. 2, FIG. 2 is an exemplary flowchart of another display method for background of application program, in accordance with an embodiment of the present invention. As shown in FIG. 2, the method according to the embodiment of the present invention includes the following steps:

S201. Capture image information by using a camera.

At the same time when a user enables an application program, a camera is also automatically turned-on and image information starts to be captured by using the camera, where a captured image is an image taken by the camera, the image information includes current environment information, that is, the captured image includes environment information about current surroundings, for example, road condition, a pedestrian, or a utility pole which is shot by the camera, and the application program may include an SMS (Short Message Service) message, a microblog or twitter, a WeChat, an e-book, etc.

S202. Set a background displaying layer of a currently running application program to two layers, where the two layers are a background first-layer and a background second-layer, and the background first-layer covers the background second-layer.

S203. Set a built-in background of the currently running application program at the background first-layer.

The background displaying layer of the application program may be set to two layers, where the background first-layer is set to the built-in background of the application program.

S204. Add the image information to the background second-layer.

The background second-layer is set to the image information, that is, the image information is added to the background displaying layer of the currently running application program, and the built-in background of the application program covers the image information.

S205. Set transparency of the built-in background of the currently running application program and display the built-in background transparently.

Specifically, the background displaying layer of the application program includes the built-in background of the application program and the image information that is captured by using the camera. The built-in background is made transparent until the image information, which is located at the layer under the built-in background, can be displayed clearly. In this case, the displayed background of the application program is the image information at the background displaying layer. Both the image information and the application program are displayed to the user, so that the user can see clearly the current environment information through the background of the application program when using the application program at the same time.

Before step S204 is executed, the method further includes:

The captured image information is mapped to a segment of memory by using DMA (Direct Memory Access, direct memory access). To transmit data with higher efficiency, a data frame of the image information may be drawn out of the memory, added to a queue, and transmitted to another queue, so that the data frame of the image information is sequentially drawn out of the queue, so as to implement the step in which the image information is added to the background second-layer.

When it is detected that the application program exits, the camera is turned off.

The image information stored in the memory is released at the same time when the camera is turned off; and therefore the image information does not occupy a memory space resource of the mobile terminal anymore and power of the mobile terminal is saved by turning off the camera.

In the embodiment of the present invention, image information which includes current environment information is used as a background of an application program for displaying, which enables a user to see clearly surroundings through the background of the application program when using the application program at the same time, so that the user can use the application program more conveniently and safely when walking, on vehicle, etc.

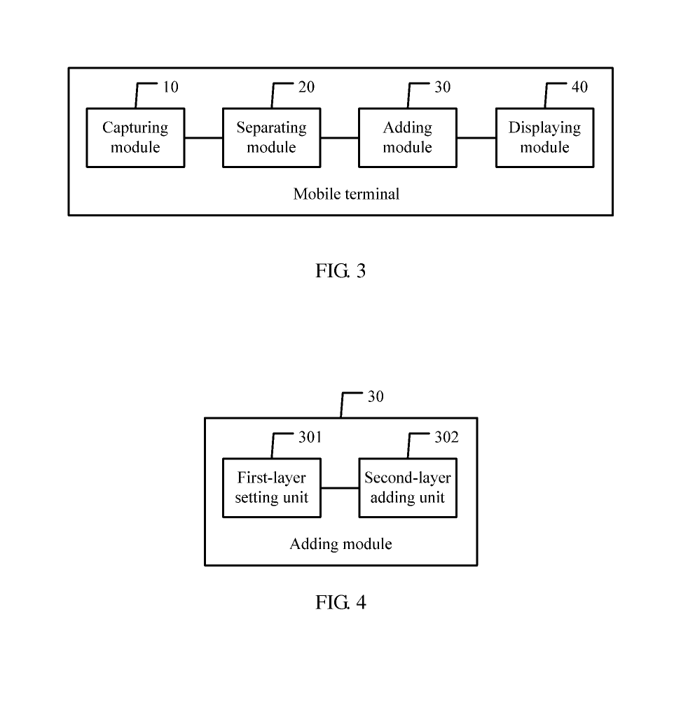

Referring to FIG. 3, FIG. 3 is a modularization schematic diagram of a mobile terminal, in accordance with an embodiment of the present invention, where the mobile terminal includes: a capturing module 10, a separating module 20, an adding module 30, and a displaying module 40.

The capturing module 10 is configured to capture image information, where the image information includes current environment information.

Specifically, at the same time when a user enables an application program, the capturing module 10 notifies a camera of being automatically turned-on and starting to capture image information, where a captured image is an image taken by the camera, the image information includes current environment information, that is, the captured image includes environment information about current surroundings, for example, road condition, a pedestrian, or a utility pole which is shot by the camera, and the application program may include an SMS (Short Message Service) message, a microblog or twitter, a WeChat, an e-book, etc.

The separating module 20 is configured to separate a background displaying layer of a currently running application program to at least two layers.

The separating module 20 may set a background displaying layer of the currently running application program to two layers, where the two layers are a background first-layer and a background second-layer, and the background first-layer covers the background second-layer. A background is separated to two layers, so as to add the image information to the background displaying layer.

The adding module 30 is configured to add the image information to the background displaying layer of the currently running application program.

The background displaying layer of the application program may be set to two layers. The adding module 30 may set one layer to a built-in background of the application program, and the other layer to the image information, that is, the image information is added to the background displaying layer of the currently running application program, and the built-in background of the application program covers the image information.

The displaying module 40 is configured to display the image information as a background of the currently running application program.

The background displaying layer of the application program includes the built-in background of the application program and the image information that is captured by using the camera. The built-in background is made transparent by the displaying module 40 until the image information, which is located at the layer under the built-in background, can be displayed clearly. In this case, the displayed background of the application program is the image information at the background displaying layer. Both the image information and the application program are displayed to the user, so that the user can see clearly the current environment information through the background of the application program when using the program. The mobile terminal may be a cell phone, a tablet computer, etc, and the camera may be a built-in camera or an external camera of this type of mobile terminal.

Referring to FIG. 4, FIG. 4 is a modularization schematic diagram of the adding module 30, in accordance with FIG. 3, where the adding module 30 includes: a first-layer setting unit 301 and a second-layer adding unit 302.

The first-layer setting unit 301 is configured to set the built-in background of the currently running application program at the background first-layer.

The background displaying layer of the application program may be set to two layers, where the first-layer setting unit 301 sets the background first-layer as the built-in background of the application program.

The second-layer adding unit 302 is configured to add the image information to the background second-layer.

The second adding unit 302 sets the background second-layer as the image information, that is, the image information is added to the background displaying layer of the currently running application program, and the built-in background of the application program covers the image information.

In the embodiment of the present invention, image information is captured by invoking a camera of a mobile terminal, and the image information which includes current environment information is used as a background of an application program for displaying, which enables a user to see clearly surroundings through the background of the application program when using the application program at the same time, so that the user can use the application program more conveniently and safely when walking, on vehicle, or the like.

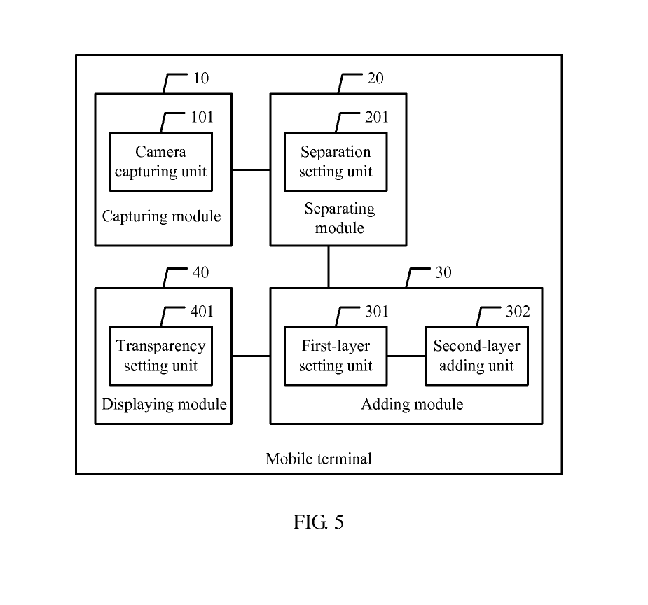

Referring to FIG. 5, FIG. 5 is a modularization schematic diagram of another mobile terminal, in accordance with an embodiment of the present invention, where the mobile terminal includes: a capturing module 10, a separating module 20, an adding module 30, and a displaying module 40.

The capturing module 10 is configured to capture image information, where the image information includes current environment information.

The capturing module 10 may include: a camera capturing unit 101, configured to capture the image information by using a camera.

Specifically, at the same time when a user enables an application program, the camera capturing unit 101 in the capturing module 10 notifies a camera of being automatically turned-on and starting to capture image information, where a captured image is an image taken by the camera, the image information includes current environment information, that is, the captured image includes environment information about current surroundings, for example, road condition, a pedestrian, or a utility pole which is shot by the camera, and the application program may include an SMS (Short Message Service) message, a microblog or twitter, a WeChat, an e-book, etc.

The separating module 20 is configured to separate a background displaying layer of a currently running application program to at least two layers.

The separating module 20 may include a separation setting unit 201, configured to set the background displaying layer of the currently running application program to two layers, where the two layers are a background first-layer and a background second-layer, and the background first-layer covers at the background second-layer.

The adding module 30 is configured to add the image information to the background displaying layer of the currently running application program.

The adding module 30 may include a first-layer setting unit 301 and a second-layer adding unit 302.

The first-layer setting unit 301 is configured to set a built-in background of the currently running application program at the background first-layer.

The background displaying layer of the application program may be set to two layers, where the first-layer setting unit 301 sets the background first-layer as the built-in background of the application program.

The second-layer adding unit 302 is configured to add the image information to the second background layer.

The second adding unit 302 sets the background second-layer as the image information, that is, the image information is added to the background displaying layer of the currently running application program, and the built-in background of the application program covers the image information.

The displaying module 40 is configured to display the image information as a background of the currently running application program.

The displaying module 40 may include: a transparency setting unit 401, configured to set transparency of the built-in background of the currently running application program and display the built-in background transparently.

The background displaying layer of the application program includes the built-in background of the application program and the image information that is captured by using the camera. The built-in background may be made transparent by the displaying module 40 until the image information, which is located at the layer under the built-in background, can be displayed clearly. In this case, the displayed background of the application program is the image information at the background displaying layer. Both the image information and the application program are displayed to the user, so that the user can see clearly the current environment information through the background of the application program when using the program. The mobile terminal may be a cell phone, a tablet computer, and the like, and the camera may be a built-in camera or an external camera of this type of mobile terminal

The mobile terminal may further include: a storing module, configured to store the image information captured by using the camera in a memory, draw a data frame of the image information out of the memory, and store the data frame of the image information in a queue mechanism manner, so that the data frame of the image information is sequentially drawn out of the queue, and the adding module 30 is notified of executing an operation of adding the image information to the background displaying layer of the currently running application program.

The mobile terminal may further include: a turning-off module, configured to turn off the camera when it is detected that the application program exits.

When the camera is turned off by the turning-off module, the image information stored in the memory is released; and therefore the image information does not occupy a memory space resource of the mobile terminal anymore and power of the mobile terminal is saved by turning off the camera.

In the embodiment of the present invention, image information is captured by invoking a camera of a mobile terminal, and the image information which includes current environment information is used as a background of an application program for displaying, which enables a user to see clearly surroundings through the background of the application program when using the application program at the same time, so that the user can use the application program more conveniently and safely when walking, on vehicle, or the like.

The modules or units provided in the embodiments of the present invention may be implemented by using an integrated circuit, for example, a CPU (Central Processing Unit, central processing unit), or by using an ASIC (Application Specific Integrated Circuit, application specific integrated circuit).

According to an actual requirement, the steps in the methods of the embodiments of the present invention may be combined and pruned, and their sequence may be adjusted.

The modules or units in the apparatus of the embodiments of the present invention may be combined, divided, and pruned according to an actual requirement.

A person of ordinary skill in the art may understand that all or a part of the processes of the method embodiments may be implemented by a computer program instructing relevant hardware. The program may be stored in a computer readable storage medium. When the program runs, the processes of the foregoing method embodiments may be included. The storage medium may be a magnetic disk, an optical disc, a read-only memory (Read-Only Memory, ROM), a random access memory (Random Access Memory, RAM), or the like.

The foregoing embodiments are merely exemplary embodiments of the present invention and are not intended to limit the scope of the claims of the present invention. Therefore, any equivalent variance made according to the claims of the present invention shall fall within the scope of the present invention.

What is claimed is:

1. A display method for background of application program, comprising:
capturing image information, wherein the image information comprises current environment information;
separating a background displaying layer of a currently running application program;
adding the image information to the background displaying layer of the currently running application program; and
displaying the image information as a background of the currently running application program.

2. The displaying method according to claim 1, wherein the capturing image information, and the image information comprises current environment information, comprises:
capturing the image information by using a camera.

3. The displaying method according to claim 2, wherein the separating a background displaying layer of a currently running application program comprises:
setting the background displaying layer of the currently running application program to two layers, wherein the two layers are a background first-layer and a background second-layer, and the background first-layer covers the background second-layer.

4. The displaying method according to claim 3, wherein the adding the image information to the background displaying layer of the currently running application program comprises:
setting a built-in background of the currently running application program at the background first-layer; and
adding the image information to the background second-layer.

5. The displaying method according to claim 4, wherein the displaying the image information as a background of the currently running application program comprises:
setting transparency of the built-in background of the currently running application program and display the built-in background transparently.

6. A mobile terminal, comprising:
a capturing module, configured to capture image information, wherein the image information comprises current environment information;
a separating module, configured to separate a background displaying layer of a currently running application program to at least two layers;
an adding module, configured to add the image information to the background displaying layer of the currently running application program; and
a displaying module, configured to display the image information as a background of the currently running application program.

7. The mobile terminal according to claim 6, wherein the capturing module comprises:
a camera capturing unit, configured to capture the image information by using a camera.

8. The mobile terminal according to claim 7, wherein the separating module comprises:
a separation setting unit, configured to set the background displaying layer of the currently running application program to two layers, wherein the two layers are a background first-layer and a background second-layer, and the background first-layer covers the background second-layer.

9. The mobile terminal according to claim 8, wherein the adding module comprises:
a first-layer setting unit, configured to set a built-in background of the currently running application program at the background first-layer; and
a second-layer adding unit, configured to add the image information to the background second-layer.

10. The mobile terminal according to claim 9, wherein the displaying module comprises:
a transparency setting unit, configured to set transparency of the built-in background of the currently running application program and display the built-in background transparently.
